(19) United States
(12) Patent Application Publication
(10) Pub. No.: US 2024/0212390 A1
(43) Pub. Date: Jun. 27, 2024

(54) ELECTRONIC DEVICE FOR PERFORMING BEHAVIOR RECOGNITION AND OPERATION METHOD THEREOF

(71) Applicant: ELECTRONICS AND TELECOMMUNICATIONS RESEARCH INSTITUTE, Daejeon (KR)

(72) Inventor: Geon Min YEO, Daejeon (KR)

(21) Appl. No.: 18/541,317

(22) Filed: Dec. 15, 2023

(30) Foreign Application Priority Data
Dec. 21, 2022 (KR) 10-2022-0180464
Nov. 7, 2023 (KR) 10-2023-0152695

(51) Int. Cl. G06V 40/20; G06V 10/34; G06V 10/48

(52) U.S. Cl. CPC G06V 40/20; G06V 10/34; G06V 10/48

(57) ABSTRACT

An electronic device for performing behavior recognition and an operation method thereof are provided. The method of operating the electronic device includes generating sampling frames for each video clip by performing sampling on a plurality of video clips at a first sampling interval, generating a cumulative feature map for each video clip based on the generated sampling frames for each video clip, and using the cumulative feature map for each video clip as an input, learning a behavior recognition model for determining a behavior of an object included in a target video clip, wherein the plurality of video clips may include the object performing a same behavior, and wherein behavior time, which represents time consumed from a start to an end of the same behavior performed by the object, may be different for each video clip.

### CROSS-REFERENCE TO RELATED APPLICATIONS

This application claims the benefit of Korean Patent Application No. 10-2022-0180464 filed on Dec. 21, 2022, and Korean Patent Application No. 10-2023-0152695 filed on Nov. 7, 2023, in the Korean Intellectual Property Office, the entire disclosures of which are incorporated herein by reference for all purposes.

### BACKGROUND

### 1. Field of the Invention

One or more embodiments relate to an electronic device for performing behavior recognition and an operation method thereof, and more specifically, to a technical field of preprocessing behavior feature points for video clip-based behavior inference.

### 2. Description of Related Art

In order to recognize a behavior using an artificial intelligence (AI)-based model, unlike simple object detection, it may be required to pass through several stages of a complex model. In other words, it may be required to detect a target object from a video clip transmitted in real time, extract a skeleton from the detected target object, and finally interpret multiple frames of the video clip to finally recognize the behavior. The AI-based model may be used in each operation described above.

The information described above may be provided as related art for the purpose of understanding the present disclosure. No claim or determination is made as to whether any of the foregoing description may be applied as prior art to the present disclosure.

### SUMMARY

Embodiments provide an electronic device and operation method of learning a behavior recognition model with video clips including behavior times of different scales for the same behavior.

Embodiments provide an electronic device and operation method that may eliminate repeated calculation by previously storing feature points of frames extracted from a target video clip in a queue.

According to an aspect, there is provided a method of operating an electronic device, the method including generating sampling frames for each video clip by performing sampling on a plurality of video clips at a first sampling interval, generating a cumulative feature map for each video clip based on the generated sampling frames for each video clip, and learning a behavior recognition model for determining a behavior of an object included in a target video clip using the cumulative feature map for each video clip as an input, wherein the plurality of video clips may include the object performing a same behavior, and wherein behavior time, which represents time consumed from a start to an end of the same behavior performed by the object, may be different for each video clip.

The generating of the cumulative feature map for each video clip may include extracting the object from the generated sampling frames for each video clip, extracting skeleton coordinates of the extracted object and generating skeleton feature points based on the skeleton coordinates, and generating the cumulative feature map for each video clip by accumulating the generated skeleton feature points for each video clip.

The method may further include determining the behavior of the object included in the target video clip using the behavior recognition model.

The determining of the behavior of the object included in the target video clip using the behavior recognition model may include generating target skeleton coordinates for each target sampling frame by extracting the target skeleton coordinates of the object from target sampling frames generated by sampling the target video clip at a second sampling interval, and determining the behavior of the object based on the target skeleton coordinates for each target sampling frame, wherein the second sampling interval may be equal to the first sampling interval.

The determining of the behavior of the object may include generating target skeleton feature points for each target sampling frame by extracting the target skeleton feature points from the target skeleton coordinates for each target sampling frame, storing the target skeleton feature points for each target sampling frame in a queue according to a temporal order, generating P target cumulative feature maps that accumulate in each section by selecting P sections from the queue, and determining the behavior of the object by inputting the P target cumulative feature maps into the behavior recognition model.

The generating of the P target cumulative feature maps that accumulate in each section may include selecting P sections adjacent in time based on a storage space of the queue corresponding to a point in time of a current target sampling frame and generating the P target cumulative feature maps by accumulating the target skeleton feature points included in each section.

According to another aspect, there is provided a method of operating an electronic device, the method including generating target skeleton coordinates for each target sampling frame by extracting the target skeleton coordinates of an object included in a target video clip from target sampling frames generated by sampling the target video clip at a second sampling interval, generating target skeleton feature points for each target sampling frame by extracting the target skeleton feature points from the target skeleton coordinates for each target sampling frame, storing the target skeleton feature points for each target sampling frame in a queue according to a temporal order, generating P target cumulative feature maps that accumulate in each section by selecting P sections from the queue, and determining a behavior of the object by inputting the P target cumulative feature maps into a behavior recognition model, wherein the behavior recognition model may be configured to be learned based on a plurality of video clips including the object performing a same behavior, and wherein behavior time, which represents time consumed from a start to an end of the same behavior performed by the object, may be different for each video clip.

The generating of the P target cumulative feature maps that accumulate in each section may include selecting P sections adjacent in time based on a storage space of the queue corresponding to a point in time of a current target sampling frame and generating the P target cumulative feature maps by accumulating the target skeleton feature points included in each section.

The method may further include learning the behavior recognition model based on the plurality of video clips.

The learning of the behavior recognition model may include generating sampling frames for each video clip by performing sampling on the plurality of video clips at a first sampling interval, generating a cumulative feature map for each video clip based on the generated sampling frames for each video clip, and learning a behavior recognition model for determining the behavior of the object included in the target video clip using the cumulative feature map for each video clip as an input, wherein the first sampling interval is equal to the second sampling interval.

According to another aspect, there is provided an electronic device including a memory configured to store instructions, and a processor configured to execute the instructions stored in the memory, wherein the instructions, when executed by the processor, may cause the electronic device to generate sampling frames for each video clip by performing sampling on a plurality of video clips at a first sampling interval, generate a cumulative feature map for each video clip based on the generated sampling frames for each video clip, and learn a behavior recognition model for determining a behavior of an object included in a target video clip using the cumulative feature map for each video clip as an input, wherein the plurality of video clips may include the object performing a same behavior, and wherein behavior time, which represents time consumed from a start to an end of the same behavior performed by the object, may be different for each video clip.

The instructions, when executed by the processor, may cause the electronic device to extract the object from the generated sampling frames for each video clip, extract skeleton coordinates of the extracted object and generate skeleton feature points based on the skeleton coordinates, and generate the cumulative feature map for each video clip by accumulating the generated skeleton feature points for each video clip.

The instructions, when executed by the processor, may cause the electronic device to determine the behavior of the object included in the target video clip using the behavior recognition model.

The instructions, when executed by the processor, may cause the electronic device to generate target skeleton coordinates for each target sampling frame by extracting the target skeleton coordinates of the object from target sampling frames generated by sampling the target video clip at a second sampling interval, and determine the behavior of the object based on the target skeleton coordinates for each target sampling frame, wherein the second sampling interval may be equal to the first sampling interval.

The instructions, when executed by the processor, may cause the electronic device to generate target skeleton feature points for each target sampling frame by extracting the target skeleton feature points from the target skeleton coordinates for each target sampling frame, store the target skeleton feature points for each target sampling frame in a queue according to a temporal order, generate P target cumulative feature maps that accumulate in each section by selecting P sections from the queue, and determine a behavior of the object by inputting the P target cumulative feature maps into the behavior recognition model.

The instructions, when executed by the processor, may cause the electronic device to select P sections adjacent in time based on a storage space of the queue corresponding to a point in time of a current target sampling frame and generate the P target cumulative feature maps by accumulating the target skeleton feature points included in each section.

Additional aspects of embodiments will be set forth in part in the description which follows and, in part, will be apparent from the description, or may be learned by practice of the disclosure.

According to an embodiment, by learning a behavior recognition model with video clips including behavior times of different scales for the same behavior, behavior inference may be possible for video clips with various behavior times and the accuracy of behavior recognition may be increased.

According to an embodiment, by previously storing feature points of frames extracted from a target video clip in a queue, repeated calculation may be eliminated and thus, inference speed may be increased.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating an electronic device according to an embodiment;

FIG. 2 is a flowchart illustrating learning of a behavior recognition model according to an embodiment;

FIG. 3 is a block diagram illustrating learning of a behavior recognition model according to an embodiment;

FIG. 4 is a flowchart illustrating determination of a behavior using a behavior recognition model according to an embodiment;

FIG. 5 is a block diagram illustrating determination of a behavior using a behavior recognition model according to an embodiment; and

FIG. 6 is a diagram illustrating a behavior recognition system according to an embodiment.

### DETAILED DESCRIPTION

Hereinafter, embodiments will be described in detail with reference to the accompanying drawings. The scope of the right, however, should not be construed as limited to the embodiments set forth herein. In the drawings, like reference numerals are used for like elements.

Various modifications may be made to the embodiments. Here, the embodiments are not construed as limited to the disclosure and should be understood to include all changes, equivalents, and replacements within the idea and the technical scope of the disclosure.

Although terms such as “first” or “second” are used to explain various components, the components are not limited to the terms. These terms should be used only to distinguish one component from another component. For example, a first component may be referred to as a second component, and similarly the second component may also be referred to as the first component.

The terminology used herein is for the purpose of describing particular embodiments only and is not intended to limit the embodiments. As used herein, the singular forms “a”, “an”, and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Hereinafter, embodiments will be described in detail with reference to the accompanying drawings.

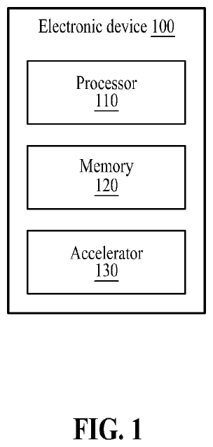

FIG. 1 is a block diagram illustrating an electronic device according to an embodiment.

Referring to FIG. 1, an electronic device 100 may include a processor 110, a memory 120, and an accelerator 130. The processor 110, the memory 120, and the accelerator 130 may communicate with each other through a bus, a network on a chip (NoC), peripheral component interconnect express (PCIe), etc. In the electronic device 100 shown in FIG. 1, only components related to the present embodiments are shown. Accordingly, it is obvious to one of ordinary skill in the art that the electronic device 100 may further include other general-purpose components in addition to the components shown in FIG. 1.

The processor 110 may perform all functions for controlling the electronic device 100. The processor 110 may generally control the electronic device 100 by executing programs and/or instructions stored in the memory 120. The processor 110 may be implemented as a central processing unit (CPU), a graphics processing unit (GPU), an application processor (AP), and the like that are included in the electronic device 100, however, embodiments are not limited thereto.

The memory 120 may be hardware for storing data processed and data to be processed by the electronic device 100. In addition, the memory 120 may store an application, a driver, and the like to be driven by the electronic device 100. The memory 120 may include a volatile memory (e.g., dynamic random-access memory (DRAM)) and/or a non-volatile memory.

The electronic device 100 may include the accelerator 130 for an operation. The accelerator 130 may process tasks that may be more efficiently processed by a separate exclusive processor (that is, the accelerator 130), rather than by a general-purpose processor (e.g., the processor 110), due to the characteristics of the operation. Here, one or more processing elements (PEs) included in the accelerator 130 may be utilized. The accelerator 130 may correspond to, for example, a neural processing unit (NPU), a tensor processing unit (TPU), a digital signal processor (DSP), a GPU, a neural engine, and the like that may perform an operation according to a neural network.

The operation of the electronic device 100 described below may be performed by one or more components of the electronic device 100.

The electronic device 100 may recognize a behavior of an object included in a video clip. The electronic device 100 may use multiple artificial intelligence (AI)-based models for behavior recognition. By using multiple AI-based models, the behavior recognition may require a lot of time. Accordingly, an issue may occur in the electronic device 100 for processing the behavior recognition in real time. In other words, processing time may increase by using multiple AI-based models, and as the processing time increases, it may be difficult to perform detailed behavior recognition, thereby reducing the accuracy of behavior recognition.

In addition, depending on the characteristics of the object, even if the behavior is the same, the behavior time of the object included in the video clip may be different, and therefore, behavior recognition of a behavior recognition model may be difficult. The behavior time may be the time from a start point of the behavior to an end point of the behavior. Furthermore, the speed of behavior recognition may be delayed, since the frame speed of the video clip needs to match to the frame speed at which the behavior recognition model has been learned.

Hereinafter, a method of overcoming the issues described above is described.

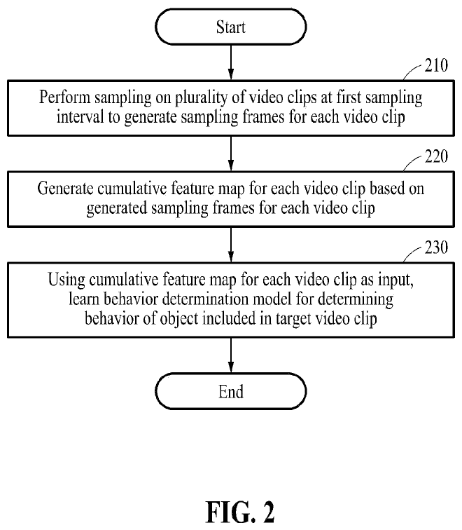

FIG. 2 is a flowchart illustrating learning of a behavior recognition model according to an embodiment.

Operations to be described hereinafter may be performed sequentially but not necessarily. For example, the order of the operations may change and at least two of the operations may be performed in parallel. Operations may be performed by any one of components of an electronic device.

In operation 210, an electronic device may perform sampling on a plurality of video clips at a first sampling interval to generate sampling frames for each video clip.

The plurality of video clips may be included in a test set. The plurality of video clips may include an object performing the same behavior. The behavior may refer to various behaviors (e.g., running, exercising, etc.) that the object may perform and is not limited to any one behavior. Behavior time of the object may be different for each video clip. The behavior time may represent time consumed from the time when the object starts the behavior until the behavior ends.

In operation 220, the electronic device may generate a cumulative feature map for each video clip based on the generated sampling frames for each video clip.

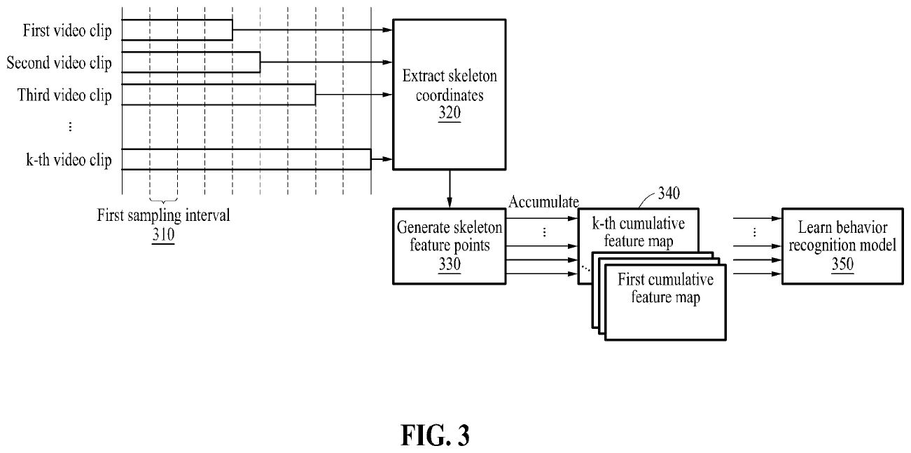

A method of generating the cumulative feature map for each video clip is described below with reference to FIG. 3.

In operation 230, the electronic device may learn a behavior determination model for determining the behavior of the object included in a target video clip using the cumulative feature map for each video clip as an input.

After operation 230, an operation of determining the behavior of the object included in the target video clip may be further performed using the learned behavior determination model.

Hereinafter, a method of learning the behavior determination model is further described.

FIG. 3 is a block diagram illustrating learning of a behavior recognition model according to an embodiment.

An electronic device may perform sampling on a plurality of video clips at a first sampling interval 310. The plurality of video clips may include a first video clip to a k-th video clip. k may be a natural number. The plurality of video clips may include different numbers of frames. For example, the first video clip may be a 40-frame video clip. The second video clip may be a 50-frame video clip.

The electronic device may perform sampling on the plurality of video clips at the first sampling interval 310 to generate sampling frames for each video clip. For example, assuming that the first sampling interval is 10 frames, the sampling frames may be sampled at an interval of 10 frames in each of the plurality of video clips. For example, in the first video clip, four sampling frames (frame 10, frame 20, frame 30, and frame 40) may be sampled. In the second video clip, five sampling frames (frame 10, frame 20, frame 30, frame 40, and frame 50) may be sampled.

Accordingly, since the video clips are sampled at the first sampling interval 310 regardless of the lengths of the video clips, the number of sampling frames for each video clip may be different. For example, the number of sampling frames of the first video clip may be 4 and the number of sampling frames of the second video clip may be 5. Here, the minimum number of frames may be referred to as N and the maximum number of frames may be referred to as M.

In operation 320, the electronic device may extract an object from the sampling frames for each video clip and may extract skeleton coordinates of the extracted object. The skeleton coordinates may be coordinates of skeletons (that is, frames) included in the object. The electronic device may extract the object from the sampling frames for each video clip using various methods. For example, the electronic device may extract the object from the sampling frames for each video clip using a machine learning model for extracting the object. However, this is only an example, and the embodiments are not limited thereto.

In addition, the electronic device may extract the skeleton coordinates from the extracted object using various methods. For example, the electronic device may extract the skeleton coordinates from the object using a machine learning model for extracting the skeleton coordinates. However, this is only an example, and the embodiments are not limited thereto.

Since one skeleton point may include an x coordinate and a y coordinate, the skeleton coordinates may be expressed as an array of [the number of skeletons×2]. However, this is only an example, and the embodiments are not limited thereto.

In operation 330, the electronic device may generate skeleton feature points based on the extracted skeleton coordinates. The skeleton feature point may be a characteristic part of the skeletons included in the object. For example, the skeleton feature point may be a joint. However, this is only an example, and the embodiments are not limited thereto.

The skeleton feature points may be expressed as a multi-dimensional array through multiple transformations of the skeleton coordinates. However, this is only an example, and the embodiments are not limited thereto.

In operation 340, the electronic device may accumulate the generated skeleton feature points for each video clip to generate a cumulative feature map for each video clip (that is, a first cumulative feature map to a k-th cumulative feature map). Here, the first cumulative feature map may correspond to the first video clip. In other words, the first cumulative feature map may be a cumulative feature map generated from the first video clip.

The cumulative feature map may be obtained by transforming the skeleton feature points generated from the corresponding video clip, several times. The cumulative feature map may be expressed as a multi-dimensional array. However, this is only an example, and the embodiments are not limited thereto.

In operation 350, the electronic device may learn a behavior recognition model using the cumulative feature map for each video clip as an input.

The behavior recognition model may be learned based on various machine learning techniques. Finally, based on the first sampling interval 310, the electronic device may learn the behavior recognition model that may perform behavior recognition from the video clips with different behavior times. The first sampling interval 310 may need to be applied equally when the behavior recognition is performed using the behavior recognition model afterwards.

Hereinafter, a method of recognizing a behavior using the learned behavior recognition model by the electronic device.

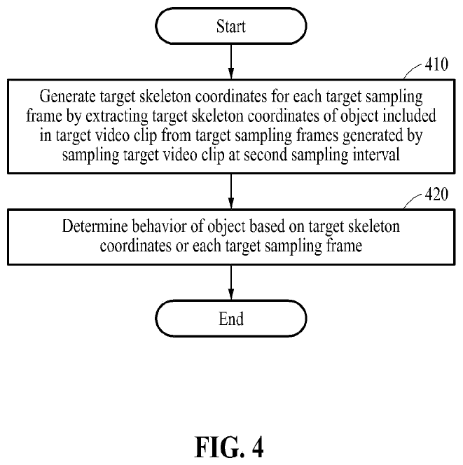

FIG. 4 is a flowchart illustrating determination of a behavior using a behavior recognition model according to an embodiment.

Operations to be described hereinafter may be performed sequentially but not necessarily. For example, the order of the operations may change and at least two of the operations may be performed in parallel. Operations may be performed by any one of components of an electronic device.

In operation 410, an electronic device may generate target skeleton coordinates for each target sampling frame by extracting the target skeleton coordinates of an object included in a target video clip from target sampling frames generated by sampling the target video clip at a second sampling interval.

In operation 420, the electronic device may determine a behavior of the object based on the target skeleton coordinates for each target sampling frame. Specifically, the electronic device may determine, using a behavior determination model, the behavior of the object by inputting target cumulative feature maps based on the target skeleton coordinates for each target sampling frame into the behavior determination model.

The behavior determination model may be a model for determining the behavior of the object learned by the method described above with reference to FIGS. 2 and 3.

Hereinafter, a method of determining the behavior of the object included in the target video clip is described in detail.

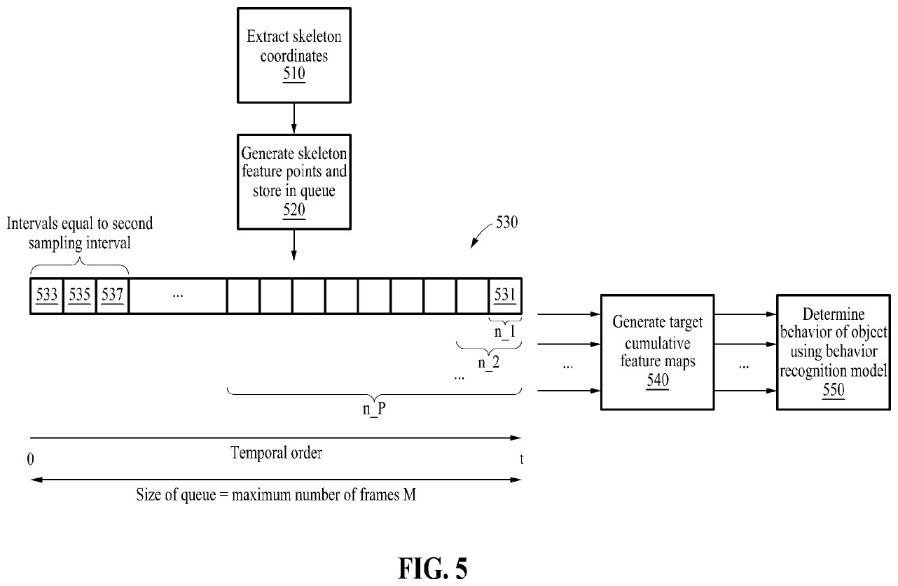

FIG. 5 is a block diagram illustrating determination of a behavior using a behavior recognition model according to an embodiment.

A target video clip may include a plurality of frames. An electronic device may perform sampling on the target video clip at a second sampling interval. In other words, target sampling frames may be sampled from the target video clip through the sampling. For example, when the target video clip includes 200 frames and the second sampling interval is 10 frames, “20” target sampling frames (frame 10, frame 20, and frame 30 to frame 200) may be sampled. Here, the second sampling interval may be equal to the first sampling interval, which is the sampling interval when the behavior recognition model is learned.

The electronic device may extract an object from the target sampling frames. The electronic device may extract the object from the target sampling frames in various methods. For example, the electronic device may extract the object from the target sampling frames using a machine learning-based object extraction model. However, this is only an example, and the embodiments are not limited thereto.

In operation 510, the electronic device may extract target skeleton coordinates from the extracted objects and may generate the target skeleton coordinates for each target sampling frame. The electronic device may extract the target skeleton coordinates from the objects in various methods. For example, the electronic device may generate the target skeleton coordinates for each target sampling frame using the machine learning-based object extraction model.

In operation 520, the electronic device may extract target skeleton feature points from the target skeleton coordinates for each target sampling frame and may store the target skeleton feature points in a queue 530. The target skeleton feature points may be stored in the queue 530 according to a temporal order. For example, frame 10 may be stored in a first storage space 533, frame 20 may be stored in a second storage space 535, and frame 30 may be stored in a third storage space 537. The size of the queue 530 may be equal to the maximum number of frames M determined as described with reference to FIG. 3.

In the queue 530, an interval between the target skeleton feature points stored in adjacent positions may be equal to the second sampling interval (that is, the first sampling interval). For example, the interval between the frame number (frame 20) corresponding to the target skeleton feature point stored in the second storage space 535 and the frame number (frame 30) corresponding to the target skeleton feature point stored in the adjacent third storage space 537 may be 10 frames (that is, the second sampling interval). In addition, the interval between the frame number (frame 20) corresponding to the target skeleton feature point stored in the second storage space 535 and the frame number (frame 10) corresponding to the target skeleton feature point stored in the adjacent first storage space 533 may be 10 frames (that is, the second sampling interval).

Accordingly, the target skeleton feature points for each target sampling frame may be accumulated and stored in the queue 530 according to the temporal order.

The electronic device may select P sections from the queue 530. The electronic device may select the P sections adjacent in time based on a storage space (e.g., a storage space 531 in FIG. 5) of the queue 530 corresponding to a point in time (e.g., t in FIG. 5) of a current target sampling frame. The electronic device may select a section n_1, a section n_2, . . . section n_P that is adjacent in time based on the point in time (e.g., t in FIG. 5) of the current target sampling frame.

In operation 540, the electronic device may generate P target cumulative feature maps by accumulating each section.

In operation 550, the electronic device may determine a behavior of the object by inputting the P target cumulative feature maps into a behavior recognition model.

According to an embodiment, the behavior recognition model may determine the behavior using each target cumulative feature map, in response to receiving the P target cumulative feature maps as inputs. In other words, less than or equal to P behaviors may be determined. The behavior recognition model may output accuracy for each of the less than or equal to P behaviors. The behavior determined with the highest accuracy may be determined to be the behavior of the object included in the target video clip.

As a result, behavior inference may be possible for video clips with various behavior times using the same sampling interval when the behavior recognition model is learned and when the behavior is inferred using the behavior recognition model. In addition, by previously storing feature points in the queue 530, repeated calculations may be eliminated and thus, inference speed may be increased.

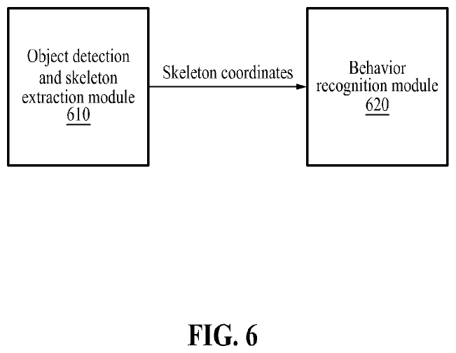

FIG. 6 is a diagram illustrating a behavior recognition system according to an embodiment.

According to an embodiment, an electronic device may include an object detection and skeleton extraction module 610 and a behavior recognition module 620.

The object detection and skeleton extraction module 610 may transmit skeleton coordinates to the behavior recognition module 620. The object detection and skeleton extraction module 610 may transmit the skeleton coordinates to the behavior recognition module 620 at a fixed frame transmission rate. The fixed frame transmission rate may refer to the transmitting of the skeleton coordinates at a sampling interval in which a plurality of video clips is sampled when the behavior recognition module 620 is learned.

The components described in the embodiments may be implemented by hardware components including, for example, at least one DSP, a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, for example, a computer program tangibly embodied in a machine readable storage device (a computer-readable medium) to process the operations of a data processing device, for example, a programmable processor, a computer, or a plurality of computers or to control the operations. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read-only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Moreover, although features may be described above as acting in specific combinations and even initially claimed as such, one or more features from a claimed combination can in some cases be excised from the combination, and the claimed combination may be changed to a sub-combination or a modification of a sub-combination.

Likewise, although operations are depicted in a predetermined order in the drawings, it should not be construed that the operations need to be performed sequentially or in the predetermined order, which is illustrated to obtain a desirable result, or that all of the shown operations need to be performed. In specific cases, multitasking and parallel processing may be advantageous. In addition, it should not be construed that the separation of various device components of the aforementioned embodiments is required in all types of embodiments, and it should be understood that the described program components and devices are generally integrated as a single software product or packaged into a multiple-software product.

The embodiments disclosed in the present specification and the drawings are intended merely to present specific examples in order to aid in understanding of the present disclosure, but are not intended to limit the scope of the present disclosure. It will be apparent to one of ordinary skill in the art that various modifications based on the technical spirit of the present disclosure, as well as the disclosed embodiments, can be made.

What is claimed is:

1. A method of operating an electronic device, the method comprising:
generating sampling frames for each video clip by performing sampling on a plurality of video clips at a first sampling interval;
generating a cumulative feature map for each video clip based on the generated sampling frames for each video clip; and
using the cumulative feature map for each video clip as an input, learning a behavior recognition model for determining a behavior of an object included in a target video clip,
wherein the plurality of video clips comprises the object performing a same behavior, and
wherein behavior time, which represents time consumed from a start to an end of the same behavior performed by the object, is different for each video clip.

2. The method of claim 1, wherein the generating of the cumulative feature map for each video clip comprises:
extracting the object from the generated sampling frames for each video clip;
extracting skeleton coordinates of the extracted object and generating skeleton feature points based on the skeleton coordinates; and
generating the cumulative feature map for each video clip by accumulating the generated skeleton feature points for each video clip.

3. The method of claim 1, further comprising:
determining the behavior of the object included in the target video clip using the behavior recognition model.

4. The method of claim 3, wherein the determining of the behavior of the object included in the target video clip using the behavior recognition model comprises:
generating target skeleton coordinates for each target sampling frame by extracting the target skeleton coordinates of the object from target sampling frames generated by sampling the target video clip at a second sampling interval; and
determining the behavior of the object based on the target skeleton coordinates for each target sampling frame,
wherein the second sampling interval is equal to the first sampling interval.

5. The method of claim 4, wherein the determining of the behavior of the object comprises:
generating target skeleton feature points for each target sampling frame by extracting the target skeleton feature points from the target skeleton coordinates for each target sampling frame;
storing the target skeleton feature points for each target sampling frame in a queue according to a temporal order;
generating P target cumulative feature maps by selecting P sections from the queue and accumulating each section; and
determining the behavior of the object by inputting the P target cumulative feature maps into the behavior recognition model.

6. The method of claim 5, wherein the generating of the P target cumulative feature maps that accumulate in each section comprises selecting P sections adjacent in time based on a storage space of the queue corresponding to a point in time of a current target sampling frame and generating the P target cumulative feature maps by accumulating the target skeleton feature points included in each section.

7. A method of operating an electronic device, the method comprising:
generating target skeleton coordinates for each target sampling frame by extracting the target skeleton coordinates of an object included in a target video clip from target sampling frames generated by sampling the target video clip at a second sampling interval;
generating target skeleton feature points for each target sampling frame by extracting the target skeleton feature points from the target skeleton coordinates for each target sampling frame;
storing the target skeleton feature points for each target sampling frame in a queue according to a temporal order;
generating P target cumulative feature maps that accumulate in each section by selecting P sections from the queue; and
determining a behavior of the object by inputting the P target cumulative feature maps into a behavior recognition model,
wherein the behavior recognition model is configured to be learned based on a plurality of video clips including the object performing a same behavior, and
wherein behavior time, which represents time consumed from a start to an end of the same behavior performed by the object, is different for each video clip.

8. The method of claim 7, wherein the generating of the P target cumulative feature maps that accumulate in each section comprises selecting P sections adjacent in time based on a storage space of the queue corresponding to a point in time of a current target sampling frame and generating the P target cumulative feature maps by accumulating the target skeleton feature points included in each section.

9. The method of claim 7, further comprising:
learning the behavior recognition model based on the plurality of video clips.

10. The method of claim 9, wherein the learning of the behavior recognition model comprises:
generating sampling frames for each video clip by performing sampling on the plurality of video clips at a first sampling interval;
generating a cumulative feature map for each video clip based on the generated sampling frames for each video clip; and
using the cumulative feature map for each video clip as an input, learning a behavior recognition model for determining the behavior of the object included in the target video clip,
wherein the first sampling interval is equal to the second sampling interval.

11. An electronic device comprising:
a memory configured to store instructions; and
a processor configured to execute the instructions stored in the memory,
wherein the instructions, when executed by the processor, cause the electronic device to:
generate sampling frames for each video clip by performing sampling on a plurality of video clips at a first sampling interval;
generate a cumulative feature map for each video clip based on the generated sampling frames for each video clip; and
using the cumulative feature map for each video clip as an input, learn a behavior recognition model for determining a behavior of an object included in a target video clip,
wherein the plurality of video clips comprises the object performing a same behavior, and
wherein behavior time, which represents time consumed from a start to an end of the same behavior performed by the object, is different for each video clip.

12. The electronic device of claim 11, wherein the instructions, when executed by the processor, cause the electronic device to:
extract the object from the generated sampling frames for each video clip;
extract skeleton coordinates of the extracted object and generate skeleton feature points based on the skeleton coordinates; and
generate the cumulative feature map for each video clip by accumulating the generated skeleton feature points for each video clip.

13. The electronic device of claim 11, wherein the instructions, when executed by the processor, cause the electronic device to:
determine the behavior of the object included in the target video clip using the behavior recognition model.

14. The electronic device of claim 13, wherein the instructions, when executed by the processor, cause the electronic device to:
generate target skeleton coordinates for each target sampling frame by extracting the target skeleton coordinates of the object from target sampling frames generated by sampling the target video clip at a second sampling interval; and
determine the behavior of the object based on the target skeleton coordinates for each target sampling frame,
wherein the second sampling interval is equal to the first sampling interval.

15. The electronic device of claim 14, wherein the instructions, when executed by the processor, cause the electronic device to:
generate target skeleton feature points for each target sampling frame by extracting the target skeleton feature points from the target skeleton coordinates for each target sampling frame;
store the target skeleton feature points for each target sampling frame in a queue according to a temporal order;
generate P target cumulative feature maps that accumulate in each section by selecting P sections from the queue; and
determine a behavior of the object by inputting the P target cumulative feature maps into the behavior recognition model.

16. The electronic device of claim 15, wherein the instructions, when executed by the processor, cause the electronic device to:
select P sections adjacent in time based on a storage space of the queue corresponding to a point in time of a current target sampling frame and generate the P target cumulative feature maps by accumulating the target skeleton feature points included in each section.
